(19) United States
(12) Patent Application Publication
(10) Pub. No.: US 2005/0137969 A1
(43) Pub. Date: Jun. 23, 2005

(54) Secure financial transaction gateway and vault

(76) Inventor: Dharmesh Shah, Brookline, MA (US)

Correspondence Address: Peter L. Brewer, Esq.;BAKER, DONELSON, BEARMAN,, CALDWELL & BERKOWITZ, P.C, 165 MADISON AVENUE, SUITE 2000, MEMPHIS, TN, 38103, US

(21) Appl. No.: 11/030,712

(22) Filed: Dec. 17, 2004

Related U.S. Application Data
(60) Provisional application No. 60/531,240, filed on Dec. 19, 2003.

(51) Int. Cl. G06F 17/60

(52) U.S. Cl. 705/39

(57) ABSTRACT

A method for securing transaction data of a financial services organization such as a mutual fund is provided. The transaction data is produced in response to orders placed by customers in a transaction creation system of the financial services organization. The transaction data is delivered from the transaction creation system into a transaction gateway before it is sent to a financial processing system. The transaction gateway processes the transaction data in order to generate a unique secure transaction token. A transaction vault is provided for storing and maintaining secure transaction tokens. The transaction gateway may also optionally produce a cumulative secure transaction token. The tokens provide a reference point for customers or regulators to determine whether any individual orders have been modified, or whether any cumulative orders have been improperly deleted.

### REFERENCE TO RELATED APPLICATIONS

This application claims priority to U.S. Provisional Patent Application No. 60/531,240 entitled “Secure Financial Transaction Gateway and Vault.” That application was filed on Dec. 19, 2003, and is referred to and incorporated herein in its entirety by reference.

### BACKGROUND OF THE INVENTION

1. Field of the Invention

The present invention relates to financial transactions. More specifically, the invention relates to a method for improving the security and integrity of financial transactions, such as transactions executed by mutual fund companies.

2. Description of the Related Art

In today's investment market, a popular form of investing is the mutual fund. A mutual fund is an investment company that pools the money of many investors, including small, individual investors, to purchase stocks, bonds or other financial instruments offered by public companies. The advantage of investing in a mutual fund is that it permits the small investor to enjoy professional money management at a substantially reduced expense. Mutual funds further offer the benefit of increased diversification, as the investor is able to own a portion of a variety of securities held through a single fund.

There are numerous mutual funds available for the investor today. Almost half of the mutual funds are equity-based mutual funds. The remaining funds comprise money market funds, debt-invested mutual funds, mortgage funds and other publicly held investment portfolios.

While individual investors represent a large percentage of an average mutual fund's shareholders, institutional investors such as banks, corporations and insurance companies also invest money in mutual funds. These institutional investors are attractive to the mutual fund companies due to their much larger and, typically, more stable purchasing habits. This presents an inevitable temptation by mutual fund companies to provide preferential treatment to the larger investors.

The integrity of the mutual fund industry is a matter of particular concern for individuals that invest their hard-earned “retirement” money. It is also a matter of concern for managers of 401(k) and other retirement or individual investment plans. Recently, the integrity of the mutual fund industry was called into question by the revelation that certain mutual funds had permitted “late-day trading.” Late-day trading is the buying and selling of mutual funds shares after regular market hours. In practice, mutual fund shares are valued only at certain time intervals. Many mutual funds make hundreds (if not thousands) of trades during the day, purchasing and selling a wide range of financial securities. It is time consuming and expensive for a mutual fund to value its shares during the trading day. Consequently, the vast majority of open-end funds allow investors to purchase and sell their funds only at the end of the day. Thus, if an investor chooses to purchase shares of a mutual fund after the trading day has closed, then that investor must buy into the mutual fund at the NAV closing price as calculated at the following business day, typically 4:00 PM ET.

In late-day trading an investor is permitted by the mutual fund to purchase shares after hours, but at the earlier closing price, that is, the already-calculated NAV. This practice gives the late-day investor the advantage of purchasing shares at an earlier price based upon new information. If any material information affecting a fund becomes public after the fund's price has been set, an opportunity is created for traders to capitalize on the stale-quote price. Traders exploiting this opportunity will buy the fund at the closed price knowing that the material information will affect the NAV. This practice is unfair because it is done at a time when other investors are not allowed to participate in the buying and selling of the fund.

Mutual fund companies are regulated by the Securities and Exchange Commission. The SEC has reacted to the allegations of late-day trading by proposing stricter rules regarding when trades must be received and processed. This has created a need for mutual fund companies to improve their security, and to be able to verify the integrity of their trading system to regulators and investors.

### SUMMARY OF THE INVENTION

A method is provided herein by which financial service organizations may provide security and integrity to financial transactions, such as mutual fund trades. In one aspect, the method can be implemented into an existing computer system of the financial services organization.

In addition, a method for securing transaction data of a financial services organization is provided. The subject transaction data is produced in response to an order placed by a customer in a transaction creation system of the financial services organization. In one aspect, the method includes the steps of delivering Transaction Data from the transaction creation system into a transaction gateway; processing the Transaction Data in the transaction gateway in order to generate a unique Secure Transaction Token in such a manner that any changes to the Transaction Data may be detected by deprocessing the Secure Transaction Token; and storing the Secure Transaction Token in a Transaction Vault.

In one embodiment, the step of processing the Transaction Data in the transaction gateway in order to generate a unique Secure Transaction Token comprises the steps of processing the Transaction Data in order to create a unique representation in a standard format, denoted as Standard Format Transaction Data; applying an algorithm to the Standard Format Transaction Data to calculate a unique token denoted as a Transaction Token; and encrypting the Transaction Token to produce a Secure Transaction Token. The method may further include processing the Secure Transaction Token in order to convert the Secure Transaction Token from binary data into regular text.

In order to verify the integrity of the Transaction Data, the Secure Transaction Token is retrieved from the Transaction Vault. The Secure Transaction Token is deprocessed in order to produce Deprocessed Transaction Data. Then, the Deprocessed Transaction Data is compared with the Transaction Data. If the data is identical, then its integrity is established.

An additional method for ensuring the integrity of Transaction Data of a financial services organization is provided herein. The Transaction Data is again produced in response to an order placed by a customer in a transaction creation system of a financial services organization. Preferably, the financial services organization is a mutual fund. The method includes delivering the Transaction Data of each of a plurality of transactions from the transaction creation system into a transaction gateway; processing each of the Transaction Data from the plurality of transactions in the transaction gateway in order to generate respective unique Secure Transaction Tokens for each transaction in such a manner that any changes to the respective items of Transaction Data may be detected by deprocessing the Secure Transaction Tokens; storing each of the Secure Transaction Tokens in a Transaction Vault; decrypting each of the Secure Transaction Tokens, producing a corresponding plurality of Decrypted Transaction Tokens; and processing the Decrypted Transaction Tokens to create a Cumulative Transaction Token, whereby the cumulative data of the Cumulative Transaction Token is digitally identified. In one aspect, the step of processing the Decrypted Transaction Tokens includes combining the individual Decrypted Transaction Tokens into Cumulative Transaction Token Data; and applying an algorithm to the Cumulative Transaction Token Data to calculate a unique token denoted as the Cumulative Transaction Token. The Decrypted Transaction Token may be encrypted to produce a Secure Cumulative Transaction Token. This Secure Cumulative Transaction Token may then be stored in the Transaction Vault.

Preferably, the method further includes the steps of retrieving the Secure Cumulative Transaction Token from the Transaction Vault; retrieving the plurality of Secure Transaction Tokens from the Transaction Vault; again decrypting each of the Secure Transaction Tokens, producing a plurality of new Decrypted Transaction Tokens; processing the new Decrypted Transaction Tokens to form a new Cumulative Transaction Token, whereby the cumulative data of the new Cumulative Transaction Tokens is given a digital identification; and comparing the digital identification of the Cumulative Transaction Token with the digital identification of the new Cumulative Transaction Token.

### BRIEF DESCRIPTION OF THE DRAWINGS

So that the manner in which the above recited features of the present invention can be better understood, certain drawings or flow charts are appended hereto. It is to be noted, however, that the appended drawings illustrate only selected embodiments of the inventions and are therefore not to be considered limiting of scope, for the inventions admit to other equally effective embodiments and applications.

FIG. 1 provides a flow chart demonstrating integration of the Secure Transaction Gateway into the computer system of a financial services organization.

FIG. 2 is a flow chart demonstrating data processing steps provided by the Secure Transaction Gateway, in one embodiment.

FIG. 3 is a flow chart showing steps for optionally further processing transaction data by the Secure Transaction Gateway.

FIG. 4 demonstrates steps through a flow chart, showing how the integrity of the transaction data may be checked.

FIG. 5 provides a flow chart showing, in an alternate method, how the integrity of the transaction data may be checked.

### DETAILED DESCRIPTION

Definitions

As used herein, the term “financial services organization” is intended to include any group, partnership, company or other organization that receives purchase and sale orders and executes transactions in response to those orders. A non-limiting example of a financial services organization is a mutual fund company.

The term “transaction data” refers to any item of electronic data reflecting a customer order for either the purchase or sale of securities. A non-limiting example is the purchase or sale of shares of a mutual fund.

The term “transaction vault” refers to any electronic data storage device or medium.

The term “secure transaction token” means an encrypted string of data representing a larger volume of data. The term “secure cumulative transaction token” means an encrypted string of data representing combined larger volumes of data.

### DESCRIPTION OF SPECIFIC EMBODIMENTS

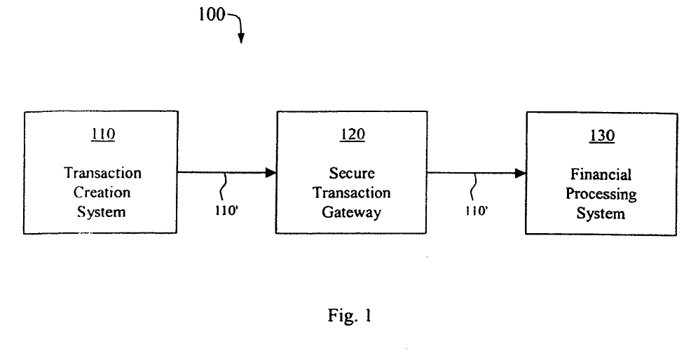

FIG. 1 provides a flow chart for a computer system 100 of a financial services organization. The features in the flow chart will be described in the context of the operation of a mutual fund company. However, it is understood that the financial services organization could also be a company that offers it own shares to the public for sale or purchase, a brokerage firm that processes orders for commodities, a stock exchange, or other such organization. The terms “securities” are intended to encompass any such items or instruments.

The flow chart of FIG. 1 shows three basic components for the computer system 100 of a financial services organization. Those components include a transaction creation system 110, a financial processing system 130 and an intermediate transaction gateway 120. Those components will be described generally, as follows.

First, the transaction creation system 110 is the vehicle by which the mutual fund company interfaces with its customers. This system 110 is typically already established by the organization as part of its operational computer system, and may include any of a number of information subsystems used by the organization to interface with investors or traders in order to receive orders. For example, an open-end mutual fund company will interface with its customers to receive orders for buying and selling its shares through subsystems within the transaction system 110. Such subsystems will include the organization's interactive web site, its voice mail system, its call center, its mail system and any other subsystem by which the organization interacts with investors to receive orders for buying and selling securities, commodities or financial instruments.

The transaction creation system 110 generates data in response to customer orders. Such data is referred to herein as Transaction Data, and is depicted by Arrow 110′. The Transaction Data 110′ is sent to the intermediate Transaction Gateway 120. The Secure Transaction Gateway 120 may, in one embodiment, be implemented into the financial service organization's existing computer system. Addition of the Gateway 120 in this instance minimizes the changes required to existing systems and processes. As will be described in greater detail below, the intermediate Transaction Gateway 120 is a secure gateway that is able to serialize transaction data and store it in encrypted form for future verification.

Finally, FIG. 1 shows that the computer system 100 includes the financial processing system 130 of the financial services organization. This system 130 processes orders placed by customers for the purchase or sale of securities. In the case of a purchase order for mutual fund shares, money is received from the customer and applied to the purchase of the corresponding net asset value (NAV) of shares. The NAV of a mutual fund represents the total assets owned by the fund, less the total liabilities, divided by the number of shares outstanding, plus an optional sales charge (also known as a sales load). In many instances, money from the customer is already available in a money market fund or from a different mutual fund. In the case of a sale order for mutual fund shares, the total value of the shares owned by the customer is returned to the customer's account. Oftentimes, the money is applied to the purchase of a different mutual fund or to a money market account. In other instances, the sales proceeds are liquidated and sent to the customer's bank or residential address.

Typically, the financial processing system 130 for the organization operates via a computer algorithm. The algorithm will determine the total value of all shares or other assets owned by the fund, minus its debts or liabilities, and divide that value by the number of outstanding shares. Any loads or fees associated with the transaction will be charged to the customer by the algorithm. With most mutual funds, transactions are consummated at the end of each business day. In the case of a small percentage of funds such as most sector funds, this calculation is made hourly during the trading day.

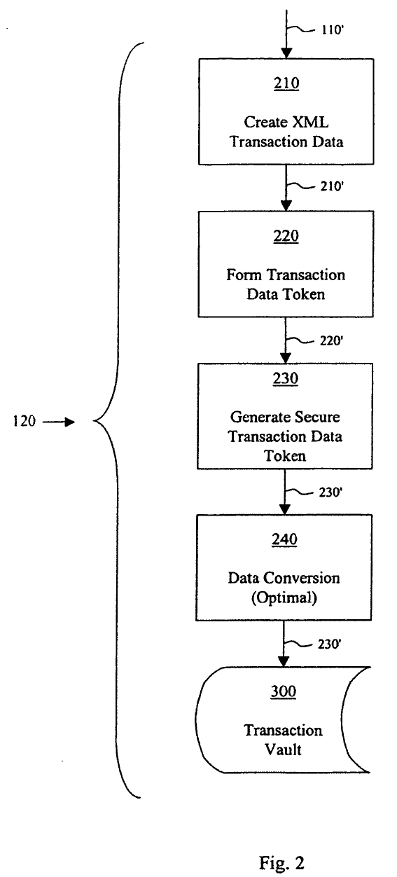

Moving now to FIG. 2, FIG. 2 presents a flow chart demonstrating data processing steps provided by the Secure Transaction Gateway 120, in one embodiment. The Transaction Gateway 120 may serve any of several functions. One function is to protect existing transactions against unauthorized changes. Another function is to protect transactions against unauthorized cancellations or deletions. Finally, the Gateway 120 may enable a third party, such as a regulator, to verify the integrity of the Transaction Data 110′.

In order to serve these functions, the Transaction Gateway 120 is operationally positioned between the transaction creation system 110 and the financial processing system 130. Thus, when a customer requests a purchase or sale transaction, the data for the transaction is digitally encoded before being sent on to the financial processing system 130. This is done by applying computer algorithms for encryption and data protection in unique ways for use by financial systems.

When data 110′ is generated by the transaction creation system 110, it is sent to the transaction gateway 120. The gateway 120 processes that data for the purpose of encrypting the data and storing it in a transaction vault. The Vault is shown at Box 300, while the steps for processing the Transaction Data 110′ are shown in boxes 210-240.

Referring now to box 210, the data 110′ for each customer transaction is serialized. This means that it is processed in such a way as to create a unique representation in a standard format. An example of such a format is an XML format. XML, more fully known as extensible Markup Language, is a simplified subset of the Standard Generalized Markup Language (SGML, ISO 8879) which provides a file format for representing data. In XML, Document Type Definition (DTD) tags carry information pertaining to a data structure and its content within a document. The tags are used by XML interpreters as a way to look for information across databases.

It is understood that the step of Box 210 is not limited to the use of XML. Other format standards may be employed. Currently there are a large and growing number of proposed and utilized standards for defining how electronic documents are structured and communicated. Within the electronic transaction industry, there are two standards frequently used, namely EDI (Electronic Data Interchange) and XML (extensible Mark-up Language). EDI is an older standard originating from the early 1970's. EDI was mainly adopted by larger enterprises, and was often customized for the application. Later, the XML standard was developed in an effort to alleviate the problem of disparate EDI standards by defining a “META” set of standards for the exchange of electronic documents over the Internet. However, there are now over 300 different XML standards in use (e.g. cXML, xCBL, ebXML). Any of these may be implemented to generate “Standard Format Transaction Data,” identified as Arrow 210′.

As a next step, the Standard Format Transaction Data 210′ is processed in order to apply a “hash” function. The hash function is represented by Box 220. A hash function is a one-way operation that transforms a data string of any length into a shorter, fixed-length value. The value represents a digital “signature.” In one aspect, the hash function is an algorithm that takes the Transaction Data 210′ and generates a 128-bit message digest from the input. The message digest from the hash function represents a mathematically unique signature, or “token.” In this respect, no two strings of data will produce the same token.

The hashing algorithm may be an available public-domain mechanism such as MD5. However, it is understood that MD5 is merely an example; other message digest algorithms may be utilized for performing the step of Box 220. For example, the SHA program may be used. SHA produces a longer hash than MD5 and is therefore considered by some to be more resistant to decoding attempts.

In the system 100 of FIG. 1, the new data generated by the hash function is known as the “Transaction Token.” The Transaction Token is seen at Arrow 220′.

In the next step, the Transaction Token 220′ is encrypted. This encryption step is seen in Box 230. Once again, a publicly available algorithm may be employed. Examples of such encryption algorithms include tripe-DES or RC4. The result of this encryption step is a new item of binary data called the “Secure Transaction Data Token.” The Secure Transaction Data Token is depicted by Arrow 230′.

The Secure Transaction Data Token 230′ is optionally processed by an algorithm that converts the binary data into regular text data. Regular text data facilitates ease of storage and transmission. The data conversion step is shown in Box 240. The Secure Transaction Data Token is generically referenced as 230′ whether it is converted or not converted.

After data processing, transactions that are sent through the secure gateway 120 are stored in a “Transaction Vault.” The Transaction Vault is again depicted by Box 300. The Transaction Vault 300 is a secure data storage mechanism based on commercially available relational database systems.

Transactions stored in the Transaction Vault 300 are maintained in the Vault 300 until such time as they may be needed for processing by downstream systems. All transactions stored in the Vault 300 are time-stamped in such a way as to prevent any type of alteration to the time-stamp once the transaction has been created. Once a transaction is stored in the secure vault 300, it is resistant to tampering including modifying the transaction or deleting the transaction. Any such tampering or unauthorized modification would be detected and auditable. By taking the steps above on every transaction stored inside the Transaction Vault 300, it can later be verified that Transaction Data sent to the Transaction Gateway has not been modified. For example, where the financial services organization is a mutual fund holding investments by 401(k) plan providers, the 401(k) plan providers may ensure their customers and federal regulators (such as the SEC) that their systems are sufficiently secure to resist unauthorized trading transactions such as those involved in the late-day trading scandal.

The above steps 210-240 are provided to make financial transactions tamper-resistant by unauthorized third parties or computer systems. In this respect, if any unauthorized changes to either the Transaction Data 210′ or the Secure Transaction Token 230′ are made, such changes could be detected by reversing the steps 240-210 above. By applying at least steps 210-230, the Transaction Data is processed in the Transaction Gateway 200 in order to generate a unique Secure Transaction Token 230′ in such a manner that any changes to the Transaction Data 210′ may be detected by deprocessing the Secure Transaction Token 230′.

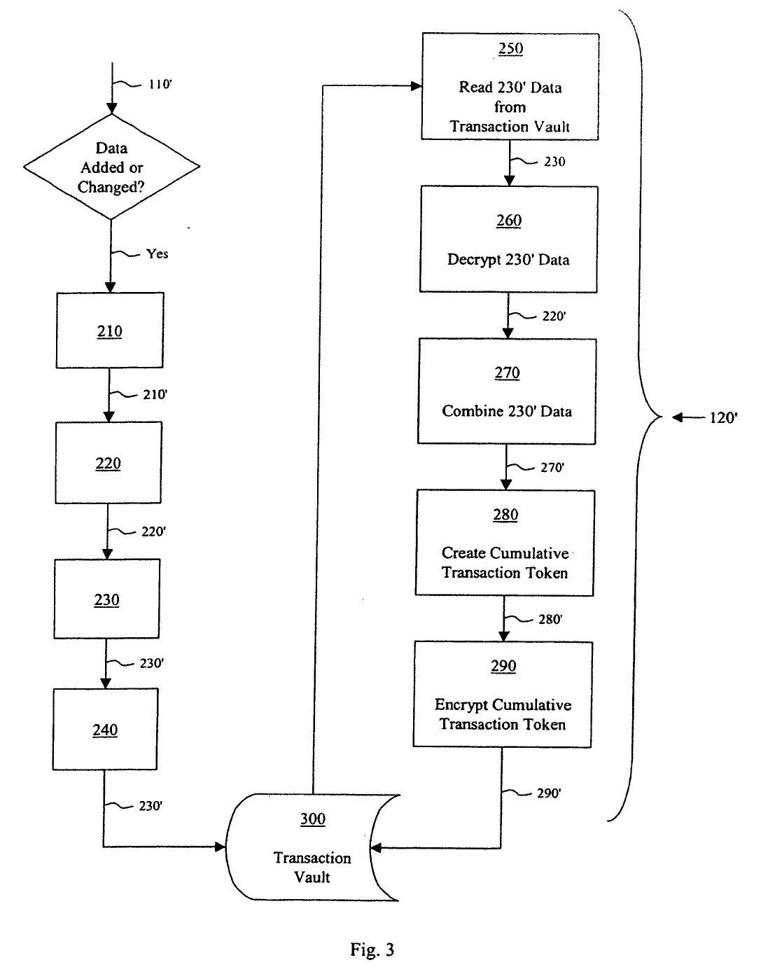

As an additional feature of the system 100, an additional series of steps may be taken to ensure that unauthorized parties or systems cannot delete transactions without detection. Such additional steps are shown in FIG. 3, described below.

FIG. 3 demonstrates additional steps 250-290. These steps are collectively numbered as 120′. The first step is demonstrated in Box 250. Here, Secure Transaction Tokens 230′ from a plurality of transactions are retrieved from the Transaction Vault 300. Then, each of the Secure Transaction Tokens 230′ is decrypted. The decryption step is shown in Box 260. If the Secure Transaction Token 230′ has been converted into regular text via step 240 of FIG. 2, then it will need to be reconverted into its binary data form before decryption. When a Secure Transaction Token 230′ is decrypted, the algorithm produces the Transaction Tokens 220′ of each of the transactions 110′.

Next, each of the individual Transaction Tokens 220′ is concatenated. This step is represented by Box 270. In this step, the data for each of the Transaction Tokens 220′ is combined to produce a single piece of data. This new combined data is known as the Cumulative Transaction Token Data 270′.

As a next step, the Cumulative Transaction Token Data 270′ is processed in order to apply a “hash” function. The hash function is represented by Box 280. The hash function transforms the data string that comprises the Cumulative Transaction Token 270′ into a shorter, fixed-length value, or digital signature. Preferably, the hash function is an algorithm that takes the Cumulative Transaction Token 270′ and generates a 128-bit message digest from the input. Again, an example of such a hashing algorithm is MD5, though other available public-domain message digest algorithms may be utilized.

In the system 100 of FIG. 1, the new data generated by the hash function 280 is known as the “Cumulative Transaction Token.” The Cumulative Transaction Token is seen at Arrow 280′. This represents a digital identifier for the cumulative transactions from the transaction creation system 110.

Next, an optional encryption algorithm is applied to the Cumulative Transaction Token 280′. This step is depicted in Box 290. The encryption algorithm produces a new piece of data called the Secure Cumulative Transaction Token. The Secure Cumulative Transaction Token is represented by Arrow 290′. The Secure Cumulative Transaction Token 290′ is stored and maintained in the Transaction Vault 300.

The steps 120′ that lead to producing the Cumulative Transaction Token 280′ and, optionally, the Secure Cumulative Transaction Token 290′, generate an item of data that serves as a reference point. This reference point allows a system administrator to demonstrate that unauthorized parties or systems have not deleted or otherwise changed a transaction. In one aspect, any addition, change or deletion of data from the Transaction Vault 300 will trigger the steps of Boxes 250-290.

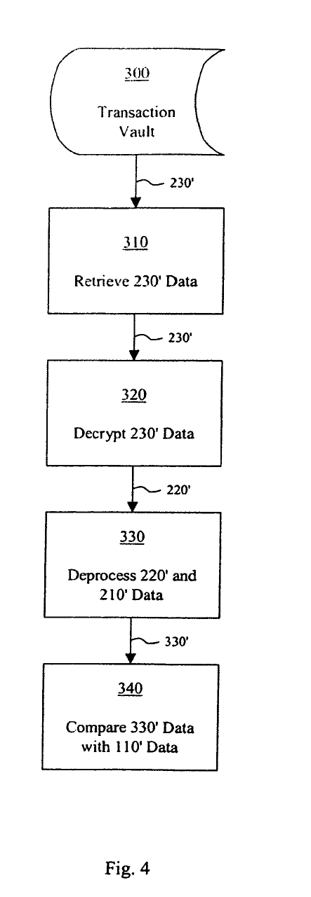

A method for ensuring the integrity of Transaction Data 110′ of a financial services organization is also provided. FIG. 4 demonstrates steps 310-340 through a flow chart showing how any unauthorized changes to the transaction data 110′ can be detected In connection with this method, Transaction Data 110′ has already been produced in response to an order placed by a customer interfacing with the transaction creation system 110 of the financial services organization. The Data 110′ has been delivered to the Transaction Gateway 120 and has been processed in order to generate the unique Secure Transaction Data Token 230′. Finally, the Token 230′ has been stored in the Vault 300. The Transaction Vault 300 is shown in FIG. 4.

In order to verify the integrity of the Transaction Data 110′, the Secure Transaction Token 230′ is retrieved from the Transaction Vault 300. This step is represented by Box 310. Next, the Secure Transaction Token 230′ is decrypted, as represented by Box 320. This produces the Transaction Data Token 220′. Then, the Transaction Data Token 220′ is deprocessed in order to produce Deprocessed Transaction Data 330′. In one aspect, this deprocessing involves the conversion of the Transaction Data Token 220′ into the Standard Format Transaction Data 210′, and the conversion of the Standard Format Transaction Data 210′ into the Transaction Data. The Deprocessed Transaction Data 330′ is compared with the original Transaction Data 110′. If the data 330′, 110′ is identical, then its integrity is established.

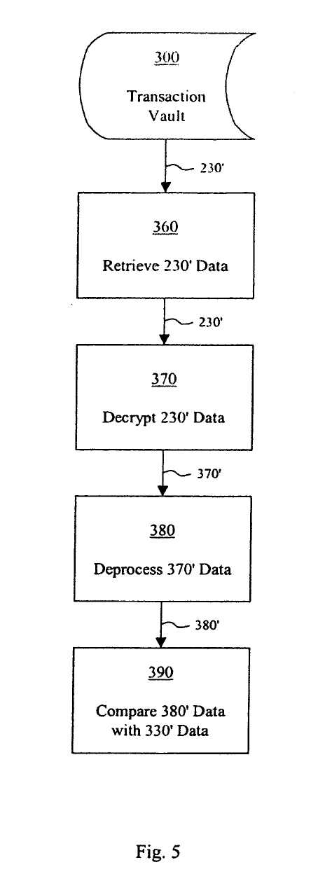

In addition, a method is provided herein for detecting unauthorized cancellations or deletions of orders. Such a method is demonstrated in one embodiment in FIG. 5, which represents yet another flow chart. A plurality of Transaction Data 110′ has already been produced in response to orders placed by customers interfacing with the transaction creation system 110 of the financial services organization. The Data 110′ has been delivered to the Transaction Gateway 120 and has been processed in order to generate respective unique Secure Transaction Data Tokens 230′. Those Tokens 230′ have been stored in the Vault 300. The Transaction Vault 300 is shown at the bottom of FIG. 5.

In order to determine whether any of the original orders have been cancelled or deleted, improperly or otherwise, the Secure Transaction Tokens 230′ are retrieved from the Transaction Vault 300. This step is represented by Box 360. Next, each of the Secure Transaction Tokens 230′ is decrypted, as represented by Box 370. The decryption process produces a corresponding plurality of Decrypted Transaction Tokens 370′.

As a next step, the Decrypted Transaction Tokens 370′ are deprocessed. Deprocessing is done in order to produce a new Cumulative Transaction Token 380′ that is digitally identified. In one aspect, the processing of the Decrypted Transaction Tokens 370′ comprises a first step of combining the individual Decrypted Transaction Tokens 370′ into Cumulative Transaction Token Data. In one aspect, this means that the Decrypted Transaction Tokens 370′ are concatenated to create Cumulative Transaction Token Data. In addition, an algorithm is applied to the Cumulative Transaction Token Data to calculate a unique token denoted as the new Cumulative Transaction Token. This new token is shown at Arrow 380′ in FIG. 5, and represents a digital identifier for the cumulative transactions. Finally, the new Cumulative Transaction Token 380′ is compared with the original Cumulative Transaction Token 280′, shown in FIG. 3. Where the Cumulative Transaction Token 280′ has been encrypted in accordance with Box 290, a decryption step would also be required.

Thus, the present inventions provide methods by which a financial service organization such as a mutual fund company may provide greater security to its transactions. In addition, a financial service organization will be able to verify the integrity of its trading system to regulatory agencies and to its investors. For example, a mutual fund could demonstrate that none of its orders have been changed or deleted.

1. A method for securing Transaction Data of a financial services organization, the Transaction Data being produced in response to an order placed by a customer in a transaction creation system of the financial services organization, comprising:
delivering the Transaction Data from the transaction creation system into a transaction gateway;
processing the Transaction Data in the transaction gateway in order to generate a unique Secure Transaction Token in such a manner that any changes to the Transaction Data may be detected by deprocessing the Secure Transaction Token; and
storing the Secure Transaction Token in a Transaction Vault.

2. The method of claim 1, wherein the step of processing the Transaction Data in the transaction gateway in order to generate the unique Secure Transaction Token comprises the steps of:
processing the Transaction Data in order to create a unique representation in a standard format, denoted as Standard Format Transaction Data;
applying an algorithm to the Standard Format Transaction Data to calculate a unique token, denoted as a Transaction Token; and
encrypting the Transaction Token to produce the Secure Transaction Token.

3. The method of claim 1, further comprising the step of:
retrieving the Secure Transaction Token from the Transaction Vault;
deprocessing the Secure Transaction Token to produce Deprocessed Transaction Data; and
comparing the Deprocessed Transaction Data with the Transaction Data to determine whether the Transaction Data has been changed.

4. The method of claim 3, wherein the step of processing the Transaction Data in the transaction gateway in order to generate the unique Secure Transaction Token comprises the steps of:
processing the Transaction Data in order to create a unique representation in a standard format, denoted as Standard Format Transaction Data;
applying an algorithm to the Standard Format Transaction Data to calculate a unique token, denoted as a Transaction Token; and
encrypting the Transaction Token to produce the Secure Transaction Token.

5. The method of claim 4, wherein:
the Secure Transaction Token is in binary data form; and
the method further comprises the step of processing the Secure Transaction Token in order to convert the Secure Transaction Token from binary data into regular text.

6. The method of claim 4, wherein:
the step of processing the Transaction Data in order to create a unique representation in a standard format is performed using an eXtensible Markup Language program.

7. The method of claim 4, wherein the step of deprocessing the Secure Transaction Token comprises the steps of:
decrypting the Secure Transaction Token to reproduce the Transaction Token;
converting the Transaction Token back into its Standard Format Transaction Data; and
processing the Standard Format Transaction Data in order to produce the Deprocessed Transaction Data.

8. The method of claim 1, wherein the Secure Transaction Token is generated before the Transaction Data is sent to a financial processing system of the financial services organization.

9. A method for determining whether Transaction Data of a financial services organization has been altered, the Transaction Data being produced in response to an order placed by a customer in a transaction creation system of the financial services organization, comprising:
delivering the Transaction Data from the transaction creation system into a transaction gateway;
processing the Transaction Data in the transaction gateway in order to create a unique representation in a standard format, denoted as Standard Format Transaction Data;
applying an algorithm to the Standard Format Transaction Data to calculate a unique token denoted as a Transaction Token;
encrypting the Transaction Token to produce a Secure Transaction Token;
storing the Secure Transaction Token in a Transaction Vault;
later retrieving the Secure Transaction Token from the Transaction Vault;
deprocessing the Secure Transaction Token to produce Deprocessed Transaction Data; and
comparing the Deprocessed Transaction Data with the Transaction Data.

10. The method of claim 9, wherein the step of deprocessing the Secure Transaction Token comprises the steps of:
decrypting the Secure Transaction Token to reproduce the Transaction Token;
converting the Transaction Token back into its Standard Format Transaction Data; and
processing the Standard Format Transaction Data in order to produce the Deprocessed Transaction Data.

11. The method of claim 10, wherein:
when the Transaction Token is encrypted to produce the Secure Transaction Token, the Secure Transaction Token is in binary data form; and
the method further comprises the step of processing the Secure Transaction Token in order to convert the Secure Transaction Token from binary data into regular text before it is stored in the Transaction Vault.

12. The method of claim 10, wherein:
the step of processing the Transaction Data in order to create a unique representation in a standard format is performed using an eXtensible Markup Language program.

13. The method of claim 10, wherein the Secure Transaction Token is generated before the Transaction Data is sent to a financial processing system of the financial services organization.

14. A method for ensuring the integrity of Transaction Data of a financial services organization, the Transaction Data being produced in response to an order placed by a customer in a transaction creation system of the financial services organization, comprising:
delivering the Transaction Data of each of a plurality of transactions from the transaction creation system into a transaction gateway;
processing each of the Transaction Data from the plurality of transactions in the transaction gateway in order to generate respective unique Secure Transaction Tokens for each transaction in such a manner that any changes to the respective items of Transaction Data may be detected by deprocessing the Secure Transaction Tokens;
storing each of the Secure Transaction Tokens in a Transaction Vault;
decrypting each of the Secure Transaction Tokens, producing a corresponding plurality of Decrypted Transaction Tokens; and
processing the Decrypted Transaction Tokens to create an original Cumulative Transaction Token, whereby the cumulative data of the Cumulative Transaction Token is digitally identified.

15. The method of claim 14, wherein the step of processing the Decrypted Transaction Tokens comprises:
combining the individual Decrypted Transaction Tokens into a Cumulative Transaction Token Data; and
applying an algorithm to the Cumulative Transaction Token Data to calculate a unique token denoted as the original Cumulative Transaction Token.

16. The method of claim 15, wherein the step of processing the Decrypted Transaction Tokens further comprises:
encrypting the original Cumulative Transaction Token to produce an original Secure Cumulative Transaction Token.

17. The method of claim 16, further comprising the step of:
storing the original Secure Cumulative Transaction Token in the Transaction Vault.

18. The method of claim 16, further comprising the step of:
retrieving the original Secure Cumulative Transaction Token from the Transaction Vault;
retrieving the plurality of Secure Transaction Tokens from the Transaction Vault;
again decrypting each of the Secure Transaction Tokens, producing a plurality of new Decrypted Transaction Tokens;
processing the new Decrypted Transaction Tokens to form a new Cumulative Transaction Token, whereby the cumulative data of the new Cumulative Transaction Tokens is given a digit identification; and
comparing the digital identification of the original Cumulative Transaction Token with the digital identification of the new Cumulative Transaction Token.
